(19) United States
(12) Patent Application Publication
(10) Pub. No.: US 2024/0248322 A1
(43) Pub. Date: Jul. 25, 2024

(54) OPTICAL FINGERPRINT SENSOR COMPRISING A DIFFRACTIVE ELEMENT

(71) Applicant: FINGERPRINT CARDS ANACATUM IP AB, GÖTEBORG (SE)

(72) Inventor: Petter ÖSTLUND, LUND (SE)

(73) Assignee: FINGERPRINT CARDS ANACATUM IP AB, GÖTEBORG (SE)

(21) Appl. No.: 18/289,237

(22) PCT Filed: May 3, 2022
(86) PCT No.: PCT/SE2022/050424

§ 371 Date: Nov. 2, 2023

(30) Foreign Application Priority Data
May 4, 2021 (SE) 2150565-6

(51) Int. Cl. G02B 27/42; G02B 5/18; G06V 10/147; G06V 40/13; G06V 40/40

(52) U.S. Cl. CPC G02B 27/4244; G02B 5/1814; G02B 5/1876; G06V 10/147; G06V 40/1318; G06V 40/45

(57) ABSTRACT

The present invention relates to an optical fingerprint sensor comprising: an image sensor comprising photodetector pixel array; a lens system arranged to focus light transmitted from an object onto the pixel array; and at least one diffractive element configured to separate spectral components of the light transmitted from the object and focused onto the pixel matrix, such that the spectral components are distributed across at least a subset of the photodetectors.

### FIELD OF THE INVENTION

The present invention relates to an optical fingerprint sensor and to an electronic device comprising such an optical fingerprint sensor, and to method for manufacturing a lens.

### BACKGROUND

Biometric systems are widely used as means for increasing the convenience and security of personal electronic devices, such as mobile phones etc. Fingerprint sensing systems, in particular, are now included in a large proportion of all newly released consumer electronic devices, such as mobile phones.

Optical fingerprint sensors have been known for some time and may be a feasible alternative to e.g. capacitive fingerprint sensors in certain applications. Optical fingerprint sensors may for example be based on the pinhole imaging principle and/or may employ micro-channels, i.e. collimators or microlenses to focus incoming light onto an image sensor.

One of the problems associated with fingerprint sensors concerns so-called spoof fingers trying to mimic a live fingerprint to thereby deceive a fingerprint sensor. If fraud by the spoof finger is successful, unauthorized access to systems may undesirably be approved or unauthorized transactions may be approved which may lead to disastrous consequences.

A common approach to assess the liveness of an object using optical fingerprint sensors is to filter the light transmitted from an object and study for example the amount of red light detected by the sensor.

However, this adds unnecessary cost to the optical fingerprint sensor. Further, the addition of filters reduces the sensitivity and spatial resolution of the optical fingerprint sensor. In addition, colour filters collect colour information by integrating over red, green and blue wavelengths which will reduce the resolution between different colour hues.

Accordingly, there is room for improvements with regards to detecting different colors in optical fingerprint sensors.

### SUMMARY

In view of above, it is an object of the present invention to provide an optical fingerprint sensor that at least partly alleviates the above described deficiencies with prior art. In particular, embodiments of the present invention provide for an optical fingerprint sensor that is able to separate light into different spectral components without the need for color filters.

According to a first aspect of the invention, there is provided an optical fingerprint sensor comprising: an image sensor comprising photodetector pixel array; a lens system arranged to focus light transmitted from an object onto the pixel array; and at least one diffractive element configured to separate spectral components of the light transmitted from the object and focused onto the pixel matrix, such that the spectral components are distributed across at least a subset of the photodetectors.

The present invention is based on the realization to include a diffractive element in the optical fingerprint sensor in order to separate different spectral components and thereby avoid using color filters. The optical fingerprint sensor effectively operates as a spectrometer in that it is able to spatially separate spectral components onto different subsets of pixels. Further, the diffractive element may be specifically tuned for providing a desired distribution of spectral components and thereby distribution of wavelengths of light across the pixels of the image sensor.

Using a diffractive element provides a cost-efficient way for detecting different wavelengths, i.e. different colors of light for subsequent processing, without reducing the sensitivity of the sensor and thereby also not reducing the spatial resolution of the fingerprint sensor.

The image sensor may be any suitable type of image sensor, such as a CMOS or CCD sensor connected to associated control circuitry. In one possible implementation the image sensor is a thin-film transistor (TFT) based image sensor which provides a cost-efficient solution for under display biometric imaging sensors. The operation and control of such image sensors for detecting light can be assumed to be known and will not be discussed herein. The image sensor may be a back side illuminated (BSI) image sensor or a front side illuminated (FSI) image sensor. The image sensor may be arranged as a Hot-zone, Large Area or Full display solution.

The optical fingerprint sensor describe herein is adapted to perform fingerprint detection based on detecting light that may be in the visible range of wavelengths and/or in the infrared range of wavelengths. Thus, the image sensor may be configured to detect any one of visible light and infrared light. In embodiments, the diffractive element may be arranged spatially separated from the image sensor by a distance sufficient for the spectral components to be separated on the sensor. In other words, the diffractive element is arranged in such a way to allow the spectral components to spread across the at least a subset of the photodetectors so that they are individually detectable by the image sensor.

The spatial separation is a distance that may be adapted to the specific implementation and configuration of the diffractive element, but advantageously provides sufficient separation of the spectral components so that they are detectable independent of each other, i.e. by different subsets of pixels. The spatial separation between the diffractive element and the photodetector pixel array may be from approximately 0.3 mm to approximately 1.3 mm, such as approximately 0.5 mm, or approximately 0.7 mm, or approximately 0.9 mm, or approximately 1 mm.

In embodiments, the diffractive element may be adapted to provide a spatial distribution of the spectral components that is different from fingerprint structure frequencies. The spatial distribution of the spectral components is distributed with a spatial frequency related to the number of spectral components per unit length/or pixel. Similarly, the fingerprint structure frequencies are structures in the fingerprint per unit length/or pixel. Generally, the spectral components are super positioned with the fingerprint structure signal. By configuring the diffractive element so that the spatial frequency of the spectral components is different from that of the distribution of fingerprint structures, the sensitivity of the sensor to the fingerprint signal is improved, or at least less affected by the distribution of the spectral components. Further, it allows for detecting the different spectral components with less influence of the fingerprint signal. Still further, it allows for filtering the signal detected by the image sensor for separating the fingerprint signal from the spectral component signal. For example, if the fingerprint structures are at a higher frequency than the spectral component distribution frequency, the image data from the image sensor may be low pass filtered for detecting the spectral components, i.e. to separate the spectral components from the signal of the fingerprint. Similarly, the image data from the image sensor may be high pass filtered for detecting the fingerprint signal.

The diffractive element may be configured in different ways, and may for example comprise at least one slit, or a grating, or a variation in refractive index, for separating the light into the spectral components.

Preferably, the subset of photodetector pixels is more than one pixel.

In embodiments, the optical fingerprint sensor may be configured to use information in the spectral components for spoof detection. For example, by comparing the intensities of different spectral components to each other, it may be concluded whether a detected object is a live finger or a spoof object. Another example is to analyze the entire spectrum in an acquired image for anti-spoofing. Various algorithms or schemes relying on comparing different colors or analyzing spectrums for anti-spoofing is known per se and will not be discussed in detail herein. Thus, it is considered known that spoof objects reflect light with different spectrum compared to that of a live object such as a finger.

The diffractive element may be arranged in various locations in the optical stack of the optical fingerprint sensor.

In one embodiment, the diffractive element may be integrated in the lens system. This provides a compact solution for the integration of the diffractive element. For example, the diffractive element may be arranged on the surface of a lens in the lens system. Accordingly, the lens is in this way advantageously a combined lens and diffractive element.

In embodiments, the lens system may comprise at least one Fresnel lens comprising grooves that constitute the diffractive element. In other words, the grooves in the optical material that form the Fresnel lens and provide the Fresnel lens with its optical properties are also shaped to provide for separation of the light into its spectral components. A Fresnel lens provides for a thin lens, and with the grooves of the Fresnel lens constituting the diffractive element, a compact and cost-efficient optical fingerprint sensor is provided.

In other embodiments, the diffractive element may be arranged over the lens system, with the lens system interleaved between the diffractive element and the image sensor.

Alternatively, the diffractive element may be arranged under the lens system.

For example, the diffractive element may be arranged on the surface of an infra-red cut off filter of the lens system. This also provides a compact solution, i.e. integrating the diffractive element with an infra-red cut off filter.

In embodiment, the diffractive element may be arranged on a substrate for wafer level optics of the optical fingerprint sensor. Wafer level optics provide for cost-efficient mass-production of lenses, and this becomes even more cost-efficient if the diffractive element is integrated with the wafer level optics lenses.

The diffractive element may be configured to distribute the spectral components in a circular pattern. In other words, the diffractive element may provide a circular distribution of the spectral components, i.e. each component is in a circular pattern on the image sensor.

Further, the diffractive element may be configured to distribute the spectral components in a linear pattern along one axis of the image sensor. Thus, the diffractive element may be configured such that the spectral components are linearly distributed, e.g. as would be the case for straight slits.

Different patterns, e.g. linear or circular provide advantages related to for example filtering of the image data for distinguishing the spectral components from other features in the images. It is therefore advantageous to have a predetermined pattern so that therefor suitable image processing can be made for taking advantage of the spectral components. Further, different types of lenses provide different patterns. For example, a Fresnel lens will provide a radially distributed diffraction and therefore also a radial distribution of spectral components leading to a circular pattern.

In some embodiments, the diffractive element may be configured to separate spectral components of the light transmitted from the object and focused onto the pixel matrix, such that the spectral components are distributed across the entire photodetector pixel array.

The optical fingerprint sensor may be configured to be arranged under an at least partially transparent display panel and configured to capture an image of the object located on an opposite side of the at least partly transparent display panel.

According to a second aspect of the present invention there is provided an electronic device comprising: an at least partly transparent display panel; the optical fingerprint sensor according to any one of the herein described embodiments, and processing circuitry configured to: receive a signal from the optical fingerprint sensor indicative of a fingerprint of a finger touching the at least partly transparent display panel, perform a fingerprint authentication procedure based on information comprised in the signal.

The optical fingerprint sensor is preferably arranged under the at least partly transparent display panel.

The electronic device may be e.g. a mobile device such as a mobile phone (e.g. Smart Phone), a tablet, a phablet, etc.

Further effects and features of the second aspect of the invention are largely analogous to those described above in connection with the first aspect of the invention.

According to a third aspect of the present invention there is provided a method for manufacturing a lens comprising a diffractive element, the method comprising: forming a grating or at least one slit in a transparent substrate; forming a lens structure on the transparent substrate such that the lens structure covers the grating or the at least one slit.

The transparent structure is such that light can travel from one side to the other side, through the lens, and be detected by an image sensor for detecting a fingerprint.

The transparent substrate may be a glass substrate or a polymer-based substrate.

The lens structure may be formed by using molding. Preferably, the lens structure may be manufactured using wafer level optics technology.

Further, the diffractive element may be manufactured using semiconductor manufacturing processes such as lithography, e.g. electron beam or optical lithography.

Further effects and features of the third aspect of the invention are largely analogous to those described above in connection with the first aspect and the second aspect of the invention.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

These and other aspects of the present invention will now be described in more detail, with reference to the appended drawings showing an example embodiment of the invention, wherein:

FIG. 1 schematically illustrates an example of an electronic device according to embodiments of the invention;

FIG. 2 is a schematic box diagram of an electronic device according to embodiments of the invention;

FIG. 3 schematically illustrates an optical fingerprint sensor according to embodiments of the invention;

FIG. 4 conceptually illustrates a set of spectral components distributed across a subset of the image sensor pixels according to embodiments of the invention;

FIGS. 5A-D conceptually illustrates different types of diffractive elements according to embodiments of the invention;

FIG. 6 conceptually illustrates a lens comprising diffractive elements according to embodiments of the invention;

FIG. 7A schematically illustrates an optical fingerprint sensor according to embodiments of the invention;

FIG. 7B schematically illustrates an optical fingerprint sensor according to embodiments of the invention;

FIG. 8A conceptually illustrates a wafer level optics lens with integrated diffractive element;

FIG. 8B conceptually illustrates a wafer level optics lens with integrated diffractive element;

FIG. 9A schematically illustrates a photodetector pixel array having spectral components distributed in a circular pattern;

FIG. 9B schematically illustrates a photodetector pixel array having spectral components distributed in a linear pattern;

FIG. 10 is a flow-chart of method steps according to embodiments of the invention; and

FIG. 11 schematically illustrates manufacturing of a lens comprising a diffractive element according to embodiments of the invention.

### DETAILED DESCRIPTION OF EXAMPLE EMBODIMENTS

In the present detailed description, various embodiments of the present invention are herein described with reference to specific implementations. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without departing from the scope of the invention.

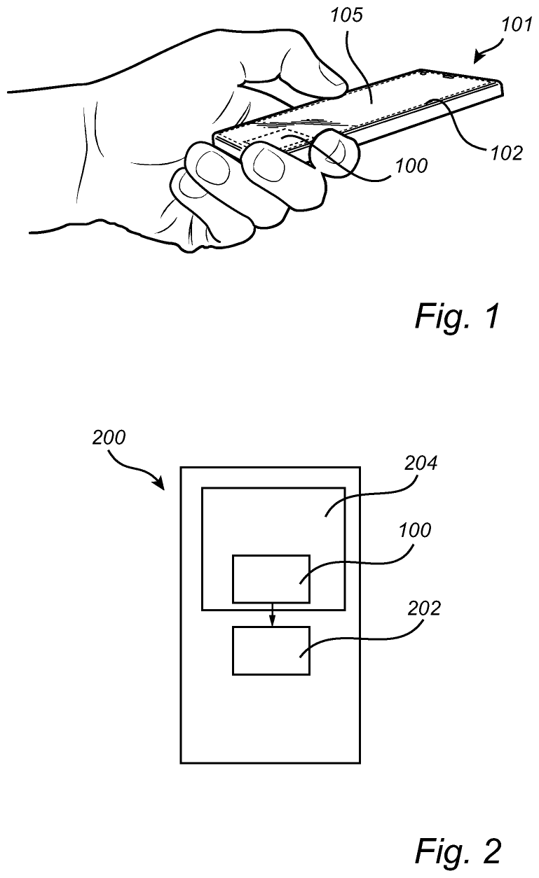

Turning now to FIG. 1, there is schematically illustrated an example of an electronic device configured to apply the concept according to the present disclosure, in the form of a mobile device 101 with an integrated in-display optical fingerprint sensor 100 and a display panel 102 with a touch screen interface 105. The optical fingerprint sensor 100 may, for example, be used for unlocking the mobile device 101 and/or for authorizing transactions carried out using the mobile device 101, etc.

The optical fingerprint sensor 100 is here shown to be smaller than the display panel 102, but still relatively large, e.g. a large area implementation. In another advantageous implementation the optical fingerprint sensor 100 may be the same size as the display panel 102, i.e. a full display solution. Thus, in such case the user may place his/her finger anywhere on the display panel for biometric authentication. The optical fingerprint sensor 100 may in other possible implementations be smaller than the depicted optical fingerprint sensor, such as providing a hot-zone implementation.

Preferably and as is apparent for the skilled person, the mobile device 101 shown in FIG. 1 may further comprise a first antenna for WLAN/Wi-Fi communication, a second antenna for telecommunication communication, a microphone, a speaker, and a phone control unit. Further hardware elements are of course possibly comprised with the mobile device.

It should furthermore be noted that the invention may be applicable in relation to any other type of electronic devices comprising transparent display panels, such as a laptop, a tablet, a desktop computer, etc.

FIG. 2 is a schematic box diagram of an electronic device according to embodiments of the invention. The electronic device 200 comprises a transparent display panel 204 and an optical fingerprint sensor 100 conceptually illustrated to be arranged under the transparent display panel 204 according to embodiments of the invention. Furthermore, the electronic device 200 comprises processing circuitry such as control unit 202. The control unit 202 may be stand-alone control unit of the electronic device 202, e.g. a device controller. Alternatively, the control unit 202 may be comprised in the optical fingerprint sensor 100.

The control unit 202 is configured to receive a signal indicative of a detected object from the optical fingerprint sensor 100. The received signal may comprise image data.

Based on the received signal the control unit 202 is arranged to detect a fingerprint. Based on the detected fingerprint the control unit 202 is configured to perform a fingerprint authentication procedure. Such fingerprint authentication procedures are considered per se known to the skilled person and will not be described further herein.

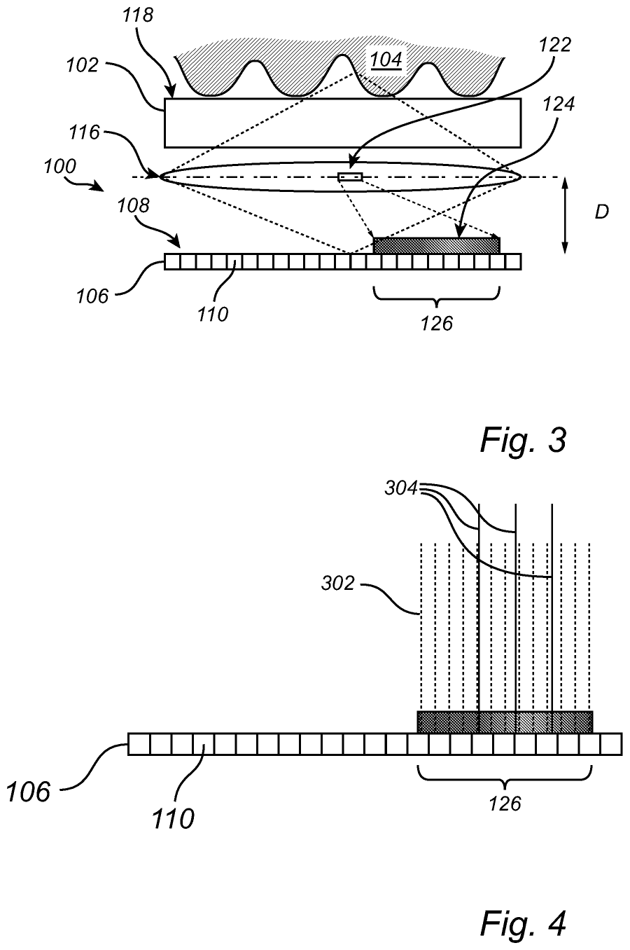

FIG. 3 schematically illustrates an optical fingerprint sensor 100 according to embodiments of the invention. The optical fingerprint sensor 100 is here arranged under an at least partly transparent display panel 102 and is configured to capture an image of an object 104 located on an opposite side of the at least partly transparent display panel 102.

The optical fingerprint sensor 100 comprises an image sensor 106 comprising a photodetector pixel array 108, where a single pixel is denoted 110. The image sensor 106 is configured to detect light for performing fingerprint detection.

The optical fingerprint sensor 100 further comprises a lens system 116 arranged to focus light transmitted from an object 104 onto the pixel array 108.

The optical fingerprint sensor 100 further comprises at least one diffractive element 122, here illustrated as an opening or slit 122 configured to separate spectral components 124 of the light transmitted from the object 104 and focused onto the pixel matrix 108, such that the spectral components are distributed across at least a subset 126 of the photodetectors.

The diffractive element 122 is arranged spatially separated from the pixel array 108 of the image sensor 106 by a distance D sufficient for the spectral components to be separated on the sensor. In other words, the diffractive element 122 is not in contact with the pixel array 108 but instead is arranged away from the pixel array 108 to allow the spectral components to spread across the at least a subset 126 of the photodetectors.

The optical fingerprint sensor may be configured to use information in the spectral components for spoof detection. In other words, image sensor provides for a dual functionality, for fingerprint detection, and as a spectrometer, using the at least the subset 126 of the photodetectors for detecting spatially distributed spectral components for performing spoof detection.

FIG. 4 conceptually illustrates a set of spectral components distributed across the subset 126 of the image sensor pixels. Each of selected and schematically illustrated spectral components are indicated by solid lines 304 for providing a representation of a spatial distribution frequency of the spectral components on the image sensor 106. The closer the lines are, the higher then spatial frequency of the spectral components. Preferably, the diffractive element is adapted to provide a spatial distribution of the spectral components that is different from fingerprint structure frequencies. For example, the pitch of grating/slits of the diffractive element may be adapted so that different wavelengths are distributed on the sensor to avoid the frequency ranges of the fingerprint structures.

With further reference to FIG. 4, the dashed lines 302 schematically illustrates the corresponding spatial separation of the fingerprint structure, having a spatial frequency, i.e. corresponding to the fingerprint structure frequencies. The fingerprint signal and the spectral components are super positioned in the signal acquired by the image sensor. Here the frequency of the fingerprint structure frequencies is higher than that of the spectral components, leading to that the image may be high-pass filtered for improving the sensitivity and resolution of the fingerprint structures in an acquired image. Further, low-pass filtering the image data allows for separating the spectral components from the fingerprint structures in the acquired image data.

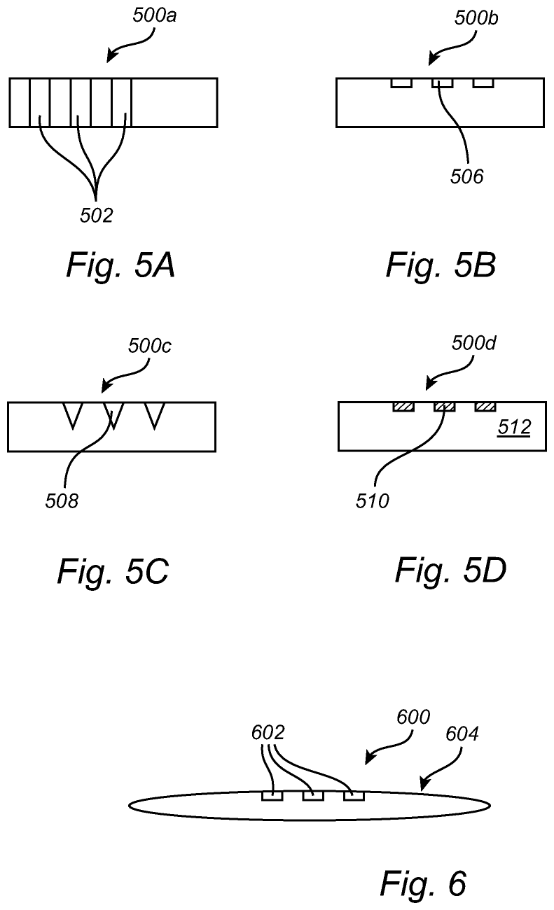

A diffractive element may be provided in various ways as is exemplified in FIG. 5A-D. Note that diffractive elements other than the ones illustrated herein are also conceivable and within the scope of the present invention.

FIG. 5A conceptually illustrates a diffractive element 500a comprising a set of slits 502 in the material of the diffractive element.

FIG. 5B conceptually illustrate a diffractive element 500b comprising a grating 506 in the form of grooves 506 in the material of the diffractive element. The grooves may have different shapes, such as for example the conceptually shown rectangular shapes, but in other possible implementations the grooves 508 may have triangular shape as in the diffractive element 500c illustrated in FIG. 5C.

It is understood that the diffractive element may comprise various types of elements, e.g. a slit, double slit or grating in one dimension or, two dimensions. The slits or grating may be rotationally symmetric or rectangular. Further, the period of the diffractive element may be adjusted to optimize the diffraction angle for different wavelengths.

In some possible implementations the diffractive element is made from materials of different refractive index, for example, FIG. 5D conceptually illustrates a diffractive element 500d comprising grooves 510 filled with a material different from the material of the body 512 of the diffractive element 500d.

The diffractive element may be arranged in various locations in the optical stack of the optical fingerprint sensor 100. For example, the diffractive elements could be placed in the lens system, on a substrate for wafer level optics, on the lens surfaces, beneath the lens system such as for example on an IR-cut filter, or above the lens system, e.g. on an IR-cut filter or some other surface.

Turning again to FIG. 3, the diffractive element 122 here being integrated in the lens system 116, in other words, the diffractive element 122 may be an integral part of the lens system 116.

In one possible implementation, the lens system 116 comprises a Fresnel lens. The Fresnel lens comprises structures such as grooves that gives the Fresnel lens its characteristic features. These grooves may be adapted to also serve as a diffractive element, similar to a grating. Thus, the diffractive element is arranged on the surface of the Fresnel lens.

FIG. 6 conceptually illustrates a lens 600 that may be part of a lens system. On the top surface, i.e. on the object side of the lens, a set of grooves 602 or slits 602 are arranged to serve as diffractive elements. Thus, the diffractive elements are arranged on the surface 604 of a lens 600 in the lens system. The diffractive elements 602 may be manufactured directly in the lens material or it may be manufactured in an additional layer of a suitable material, e.g. a glass material or a polymer, on the top surface 604 of the lens 600.

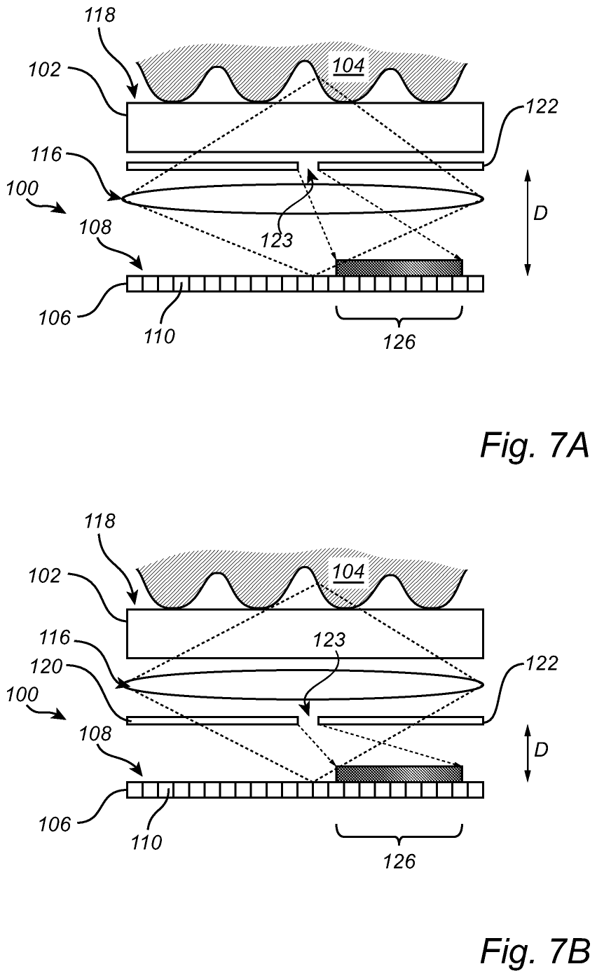

FIG. 7A conceptually illustrates another possible implementation where the diffractive element 122 comprising e.g. a slit or grating 123 is arranged over the lens system 116, with the lens system 116 interleaved between the diffractive element 122 and the image sensor.

FIG. 7B conceptually illustrates another possible implementation where the diffractive element 122 is arranged under the lens system 116 between the image sensor 106 and the lens system 116.

For example, as discussed above the diffractive element 122 may be arranged on the surface of an infra-red cut off filter which again provides for a compact and cost-efficient solution.

Of course, in implementations where IR light is detected by the image sensor for acquired biometric information, IR-cut filters are omitted.

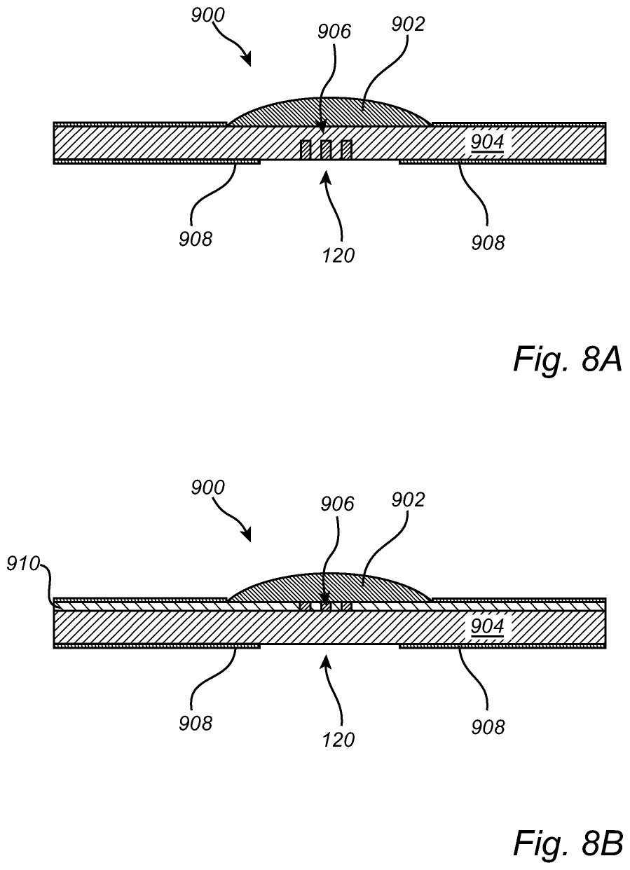

FIG. 8A conceptually illustrates one possible implementation of the present invention where the diffractive element 902 is arranged on a substrate 904 of a wafer level optics component 900 of the optical fingerprint sensor. Using wafer level optics technology, a lens 902 may be manufactured on a glass substrate 904. An imprinting tool is used for forming the lens 902, or typically multiple lenses simultaneously, in a mold material suitable for lenses. For embodiments of the present invention, the diffractive element 906, such as slits or a grating, may be formed in the glass substrate 904, in the aperture 120 formed between opaque layers 908. This advantageously provides well integrated and cost-efficient lens system comprising both diffractive elements and the lens. Note that the diffractive elements 906 are only conceptually illustrated and are not to scale. Further, the diffractive element is here shown to be located in the bottom surface of the glass substrate 904 directly under the lens 902 where it will be facing towards the image sensor. The diffractive elements may equally well be located in the top surface directly under the lens 902 material, e.g. over-molded by the lens 902.

FIG. 8B conceptually illustrates another possible implementation of the present invention where the diffractive element 902 is arranged on a substrate 904 of a wafer level optics component 900 of the optical fingerprint sensor. In this embodiment, the diffractive elements 902 are made in a separate layer 910 or material, such as optically transparent glass or polymer. The diffractive elements 902 may be made by lithography techniques in the layer 910 which may be deposited on the substrate 904 followed by lithography for manufacturing the diffractive elements 902. It is also a possibility to firstly manufacture the diffractive elements 902 on a substrate 910 and then subsequently apply the substrate 910 on the lens substrate 904.

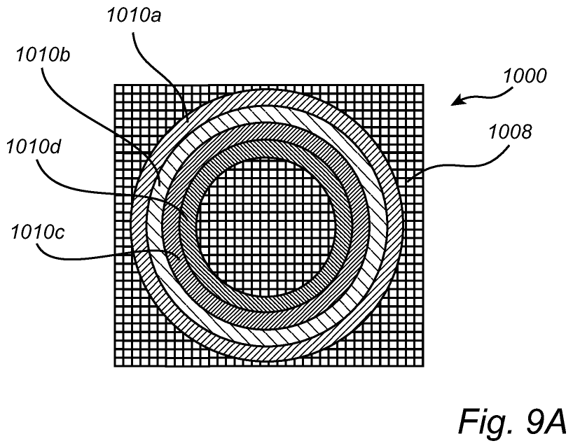

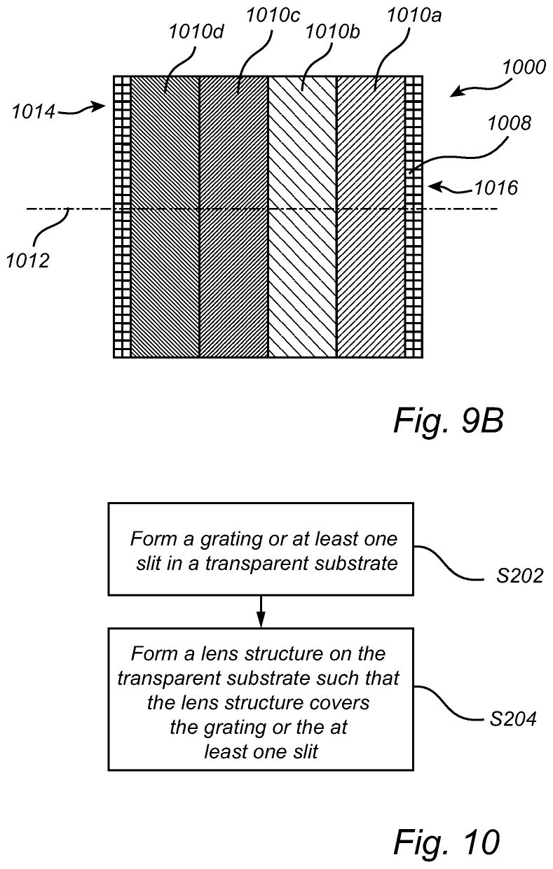

The diffractive element may provide different shapes of the spectral component distribution. FIGS. 9A and 9B conceptually illustrates two examples of this.

FIG. 9A conceptually illustrates a photodetector pixel array 108 comprising a set of pixels 1008. The diffractive element is here configured to distribute the spectral components 1010a-d in a circular pattern on the photodetector pixel array 108.

In FIG. 9B, the diffractive element is configured to distribute the spectral components 1010a-d in a linear pattern along one axis 1012 of the image sensor, from one side 1014 to the opposite side 1016.

In the depicted embodiments, the diffractive element distributes the spectral components across a subset of the photodetector pixels. However, the diffractive element may be configured to separate spectral components of the light transmitted from the object and focused onto the pixel matrix, such that the spectral components are distributed across the entire photodetector pixel array.

The display panel 102 may comprise a display comprising individually controllable light emitting units, e.g. display pixels. The pixels may provide e.g., red, green, and blue light. Various types of displays can be used in accordance with embodiments. For example, displays based on OLED, u-LED with any type of tri-stimulus emission like RGB, CMY or others.

As is understood, there are suitable openings or optical paths past the display so that the light beams being transmitted from the object 104 can reach the image sensor 106. For example, the color controllable light source may be a display not being completely opaque. In other words, this allows the light from the object to reach the sensor. Further, the controllable light sources of the display may be used for illuminating the object during image acquisition. The light from the display is then reflected by the object 104 towards the image sensor 106.

Herein, an optical fingerprint sensor 100 configured to capture an image of a finger 104 in contact with an outer surface 118 of the display panel 102 is described. However, it should be understood that the optical fingerprint sensor 100 may be arranged under any cover structure which is partially transparent, as long as the image sensor receives a sufficient amount of light to capture an image of a biometric object 104 in contact with the outer surface of the cover structure, such as a fingerprint or a palmprint.

Each pixel 110 is an individually controllable photodetector arranged to detect an amount of incoming light and to generate an electric signal indicative of the light received by the detector. The image sensor 106 may be any suitable type of image sensor, such as a CMOS or CCD sensor connected to associated control circuitry. However, the image sensor 106 may in some implementations be a thin-film transistor (TFT) based image sensor which provides a cost-efficient solution. The operation and control of such an image sensor can be assumed to be known and will not be discussed herein. The image sensor may be adapted to detect visible light and/or infrared light. Note that the pixels shown herein are only conceptually illustrated and are not to scale.

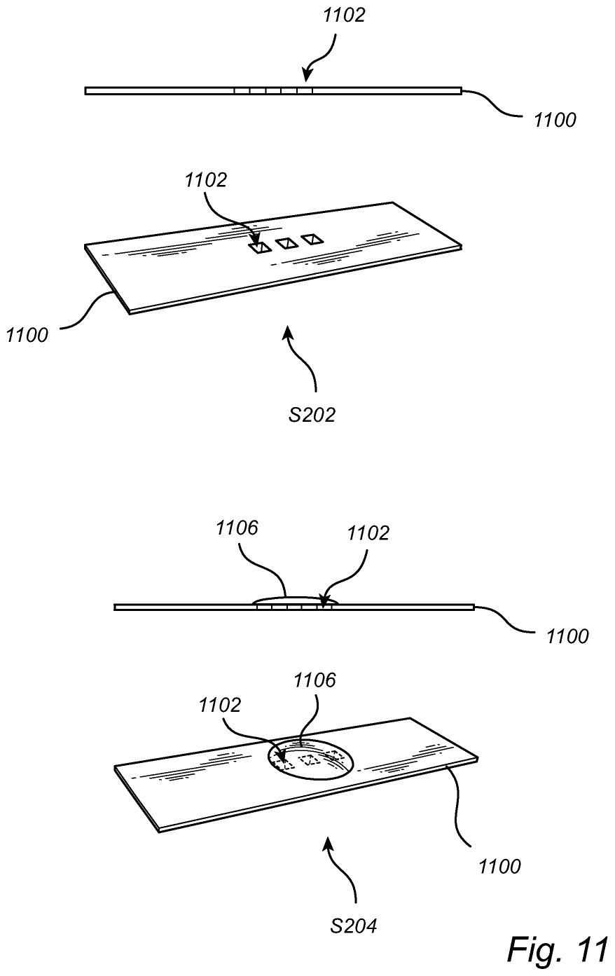

FIG. 10 is a flow-chart of method steps for manufacturing a lens comprising a diffractive element and FIG. 11 schematically illustrates a process flow for manufacturing such a lens according to one possible embodiment. FIG. 10 and FIG. 11 will now be described in conjunction.

In a step S202, forming a grating 1102 or at least one slit 1102 in a transparent substrate 1100. The transparent substrate may for example be a glass substrate or a transparent polymer substrate. The substrate should be suitable for optical application and allow for transmission of light through the material of the substrate 1100 such that an image sensor arranged under the substrate can receive and detect light transmitted from the opposite side of the substrate.

In step S204, forming a lens structure 1106 on the transparent substrate such that the lens structure covers the grating 1102 or the at least one slit 1102.

The lens structure 1106 is preferably formed by molding. For example, molding the lens structure may be performed using wafer level optics technology. Further, the diffractive element may be manufactured using semiconductor manufacturing processes such as lithography, e.g. electron beam or optical lithography.

The grating or slits may be made in a separate layer arranged on the substrate 1100 or they may be made directly in the lens substrate 1100.

In the drawings, a lens system is depicted and represented as a single lens. The invention is not limited to a specific type of lens system and is applicable to e.g., both camera-based lens systems and to microlens systems where each microlens is configured to focus light onto a subset of photodetectors to provide sub-images and a final image is obtained by stitching of the sub-images. The diffractive element may be integrated in any one of many envisaged lens systems.

A control unit may include a microprocessor, microcontroller, programmable digital signal processor or another programmable device. The control unit may also, or instead, include an application specific integrated circuit, a programmable gate array or programmable array logic, a programmable logic device, or a digital signal processor. Where the control unit includes a programmable device such as the microprocessor, microcontroller or programmable digital signal processor mentioned above, the processor may further include computer executable code that controls operation of the programmable device. It should be understood that all or some parts of the functionality provided by means of the control unit (or generally discussed as “processing circuitry”) may be at least partly integrated with the optical fingerprint sensor.

Even though the invention has been described with reference to specific exemplifying embodiments thereof, many different alterations, modifications and the like will become apparent for those skilled in the art. Also, it should be noted that parts of the imaging device may be omitted, interchanged or arranged in various ways, the imaging device yet being able to perform the functionality of the present invention.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. An optical fingerprint sensor configured to be arranged under an at least partially transparent display panel and configured to capture an image of the object located on an opposite side of the at least partly transparent display panel, the optical fingerprint sensor comprising:
an image sensor comprising photodetector pixel array configured to detect light for performing fingerprint detection;
a lens system arranged to focus light transmitted from an object onto the photodetector pixel array; and
a diffractive element configured to spatially distribute spectral components of the light transmitted from the object and focused onto the photodetector pixel array, wherein the diffractive element is arranged spatially separated from the image sensor by a distance sufficient for the spectral components to be spatially spread onto different subsets of photodetectors of the image sensor, wherein the diffractive element is arranged on a substrate for wafer level optics integrated with a wafer level optic lens of the lens system.

2. The optical fingerprint sensor according to claim 1, the diffractive element being adapted to provide a spatial distribution of the spectral components that is different from fingerprint structure frequencies.

3. The optical fingerprint sensor according to claim 1, wherein the diffractive element comprises at least one slit, or a grating, or a variation in refractive index, for separating the light into the spectral components.

4. The optical fingerprint sensor according to claim 1, configured to use information in the spectral components for spoof detection.

5. The optical fingerprint sensor according to claim 1, wherein the diffractive element is integrated in the lens system.

6. The optical fingerprint sensor according to claim 5, wherein the diffractive element is arranged on the surface of a lens in the lens system.

7. The optical fingerprint sensor according to claim 5, wherein the lens system comprises at least one Fresnel lens comprising grooves that constitute the at least one diffractive element.

8. The optical fingerprint sensor according to claim 1, wherein the diffractive element is arranged over the lens system, with the lens system interleaved between the diffractive element and the image sensor.

9. The optical fingerprint sensor according to claim 1, wherein the diffractive element is arranged under the lens system.

10. The optical fingerprint sensor according to claim 1, wherein the diffractive element is arranged on the surface of an infra-red cut off filter of the lens system.

11. The optical fingerprint sensor according to claim 1, wherein the diffractive element is configured to distribute the spectral components in a circular pattern.

12. The optical fingerprint sensor according to claim 1, wherein the diffractive element is configured to distribute the spectral components in a linear pattern along one axis of the image sensor.

13. The optical fingerprint sensor according to claim 1, wherein the diffractive element is configured to separate spectral components of the light transmitted from the object and focused onto the pixel matrix, such that the spectral components are distributed across the entire photodetector pixel array.

14. An electronic device comprising:
an at least partly transparent display panel;
the optical fingerprint sensor according to claim 1, and
processing circuitry configured to:
receive a signal from the optical fingerprint sensor indicative of a fingerprint of a finger touching the at least partly transparent display panel,
perform a fingerprint authentication procedure based on information comprised in the signal.

15. The electronic device according to claim 14, wherein the electronic device is a mobile device.

16. A method for manufacturing a lens comprising a diffractive element, the method comprising:
forming a grating or at least one slit in a transparent substrate, wherein the transparent substrate is a glass substrate or a polymer-based substrate for wafer level optics;
forming a lens structure using wafer level optics technology on the transparent substrate such that the lens structure covers the grating or the at least one slit.

17. The method according claim 16, wherein the grating or slit is manufactured using lithography.
